(19) United States
(12) Patent Application Publication
(10) Pub. No.: US 2017/0329948 A1
(43) Pub. Date: Nov. 16, 2017

(54) DIGITAL SIGNATURE WITH CUSTOM FINGERPRINT

(71) Applicant: GIUSEPPE FARINA, ROMA (IT)

(72) Inventor: GIUSEPPE FARINA, ROMA (IT)

(21) Appl. No.: 15/533,036

(22) PCT Filed: Sep. 18, 2015
(86) PCT No.: PCT/IT2015/000236

§ 371 Date: Jun. 5, 2017

(30) Foreign Application Priority Data
Dec. 5, 2014 (IT) RM2014A000710

(51) Int. Cl. G06F 21/32; G06K 9/00; H04W 12/06; G06F 21/64

(52) U.S. Cl. CPC G06F 21/32; H04W 12/06; G06K 9/00006; G06F 21/645

(57) ABSTRACT

Computer method that allows you to uniquely identify the holder of the digital signature with custom imprint filed with the certifying authority. It is constituted by imprint of fingertip or the owner fingers signature and biographical data of the same and characterized by the use of the fingertip finger or fingers, for taking impressions comparable that originally deposited at the certifying authority. The deposit of the impression at the certification authority, takes place during the signature request Digital of the person concerned or the request of the certificate of electronic signature also Remote, which is associated with filing an identification number and unique (secret code) connected directly to the holder of the certificate, represented by a hash (fingerprint) personalized impression of the owner. Method is activated by a suitable computing device (FIG. 1) (FIG. 2 Configuration example) The electronic document (FIG. 1/a), signed by the person holding the digital signature, the certifying body shall affix its reference links as a sign of certification (FIG. 1/e).

### PRIOR ART

In the current prior art, the following digital signature computerized methods have been developed:
1) Digital signature. It is a qualified electronic signature system based on asymmetric cryptography;
2) Graphometric signature—advanced electronic signature based on the use of a specific market hardware on which any user may affix his graphometric signature.

This system performs the biometric identification of five parameters: 1. Rhythm 2. Speed, 3. Pressure, 4. Acceleration, 5. Movement.

The problems associated to the use of digital and graphometric signature in the context of electronic signatures result from the very nature of biometric signature: the main limitation is the obvious instability of the biometric sample over time, which may lead to significant variations of the results arising from the comparison between the templates during the verification stage and cause a false acceptance or a false rejection.

The use of the above-mentioned identification systems, in the presence of disputes relating to the identification of the digital signature, cannot ensure that the signature on the document is attributable to the rightful owner.

Research report Application number IO53986, ITRM20140710—Pertinent documents referred to in the patents:
WO 02/073877 A2 (BRANDY PASCAL [US]) 19 Sep. 2002;
US 2001/052541 A1 (KANG HYUNG-JA [K R] ET AL) 20 Dec. 2001;

The patents mentioned above are not relevant for the object of the current patent application.

### DESCRIPTION TEXT

As is known, the fingerprints are part of the phenotype of each individual with its own immutable and peculiar features, as the configuration and the, pattern details are persistent and never change throughout one's life. The invention consists of a computerized method in which the digital signature with custom fingerprint acquires an evidentiary effect equal to the traditional signatures, which meet all the legal requirements.

The invention described herein is based on a digital signature method represented by the electronic data collection, attached or connected through logical associations to other electronic data, used as a computerized identification method.

The computerized method introduces innovative authentication elements which allow for the unique identification of the owner of the digital signature through the custom fingerprint filed at the certifying body.

This method includes the fingerprint(s) of the owner, as well as his signature and personal data; characterized by the use of the fingerprint(s) for the detection of the fingerprint comparable with the original one filed by the subscriber at the certifying body.

The fingerprints are filed at the certifying body upon the request for the digital signature or the qualified electronic signature certificate, also remote, to which an identifying and unique number (secret code) is associated, directly connected and controlled exclusively by the certificate holder, represented by a data string calculated through a hash function of the owner's custom footprint;

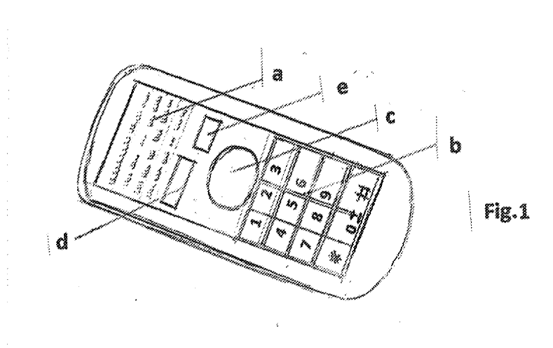

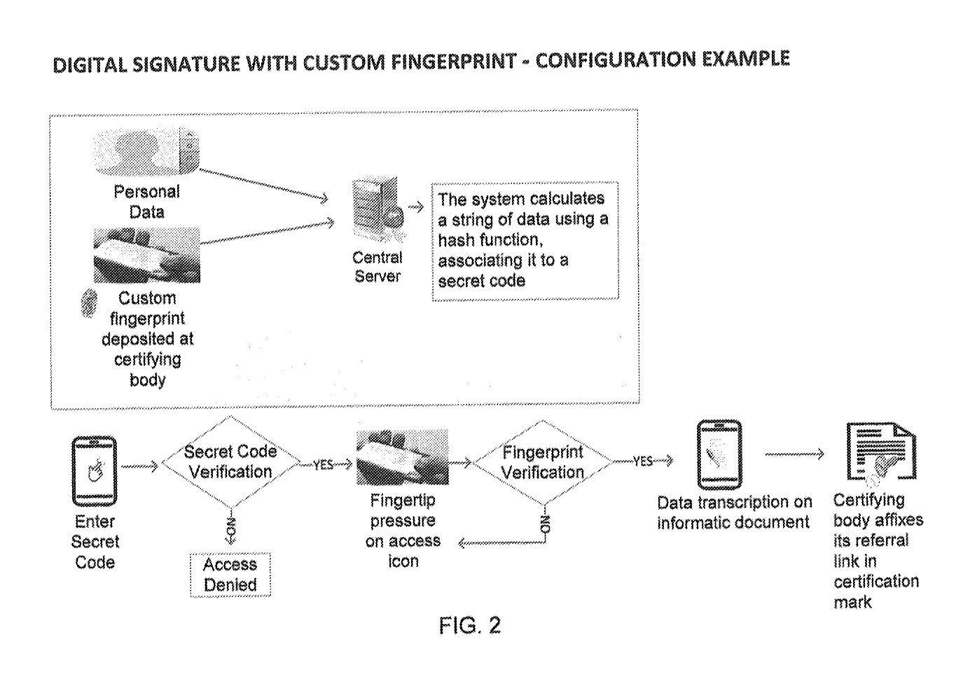

Moreover, the above-mentioned data string (hash) is associated to a personal unique code (also called PIN) which allows for the transmission, even via https protocol and server, of one Or more files formatted to the electronic signature device (FIG. 1) (FIG. 2 Configuration example), including parameters and protections for a proper implementation of the digital signature, activated only after the procedure described below:

a) the owner of the digital signature with custom fingerprint enters his secret code (FIG. 1/b), issued by the certifying body, in a computer system (FIG. 1) (FIG.2) (e.g., smartphones, tablets, PCs, etc.) activating on the display of the same an access icon (FIG. 1/c) to the centralized system of the certifying body; where: if the PIN entered by the user corresponds to the one stored in the database of the certifying body, the software (or libraries) on the computerized device-system (FIG. 1) (FIG. 2), changes its screen, showing the interface used to read the custom footprint; if the PIN entered by the user does not correspond to the one stored in the security databases of the certifying body, the software (or libraries) on the computerized device-system (FIG. 1) (FIG. 2) shall respond with art access denied error and the procedure shall be interrupted;

b) if the access is authorized, the owner of the digital signature rests his finger on the access icon (FIG. 1/c) and the centralized system of the certifying body, once recognized the digital fingerprint through the above-mentioned security and protection systems, writes on a computer file (FIG. 1/a), which receives from or transmits to the other party concerned, the personal data and the cryptographic key to sign the document, which are undersigned by the same (FIG. 1/d) as a sign of approval, agreement and termination of a legal relationship etc. On the digital document, signed by the owner of the digital signature, the certifying body shall affix his reference Link as a sign of certification (FIG. 1/e). In case of disputes concerning the owner identification, the certifying body of the owner's digital signature issues a computer certificate attesting to the fact that the signature, affixed to the document, belongs exclusively to the holder.

c) At any time, the holder of the digital signature may revoke, using an additional secret code, the digital signature filed at the certifying body.

1) Computerized method that allows one to uniquely identify the owner of the digital signature with custom print of the finger or toe fingers of the owner or holder and personal data filed by the same at the certifying institution, where fingerprint detection is comparable to that filed by the subscriber at said certifying institution; characterised by the fact that:
a) authentication features allow one to uniquely identify the owner of the digital signature with custom imprint filed by the certification institution;
b) the fingerprint storage at the certification institution takes place at the request of the digital signature of the person concerned;
c) this fingerprint has a settled a unique ID number (secret code), connected and managed only directly by the certificate holder, represented by a string of data calculated by using a hash function of the custom fingerprint of the holder;
d) that string of data, is associated with a unique code (PIN) that allows a transmission, also via https and server,of one or more files formatted by the electronic signature device (FIG. 1) and (FIG. 2 Configuration example) including parameters and protection for the proper implementation of the digital signature.

2) IT method, as claimed in claim 1, where cryptographic activation key of the signer is performed using the following steps:
a) The holder of a digital signature with custom fingerprint, types his secret code on a computer system (FIG. 1) (FIG. 2) (e.g. smartphone, tablet, PC etc.) 1/b) issued by the certification body, turning on the display, a button (FIG. 1/c) to the centralized system of certifying institution; where: if the comparison of the PIN entered by the user is the same as the one stored within the database, the software certification institution (or libraries) of your device-computer system (FIG. 1) (FIG. 2) edit the screenshot, showing the user an interface to read the custom fingerprint; if the comparison of the PIN entered by the user is not the same as the one stored in the database of the certification, the application of the device-computer system (FIG. 1) (FIG. 2) will respond with an access denied and the process will be interrupted;
b) if access is detected, the owner of the digital signature could place the finger on fingertip access icon (FIG. 1/c) and the centralized system of certifying will compare the result of hash function of the user's fingerprint with the one stored in the database, and if it succeeds is enabled the identification of the signer of the document, and then the connection ant thus is granted the connection of the signatory, enabled by the recognition of his fingerprint through the digital security requirements and security outlined above; at this point, the system writes on the electronic document (FIG. 1/a), signed by the user, received or trans ted to the other party concerned full personal data and the cryptographic key to subscribe the document, signed by the user (FIG. 1/d) as a sign of approval, accession, conclusion of a legal relationship; on the digital document, signed by the holder of the digital signature, certifying institution puts its reference Link as title certification (FIG. 1/c);
c) digital signature holder may revoke at any time, thanks to a further secret code, the digital signature filed at the certifying institution.
